(19) United States
(12) Patent Application Publication
(10) Pub. No.: US 2025/0022369 A1
(43) Pub. Date: Jan. 16, 2025

(54) METHOD AND DEVICE FOR RECOGNISING THE VALIDITY OF A VEHICLE PARAMETER

(71) Applicant: JENOPTIK Robot GmbH, Monheim am Rhein (DE)

(72) Inventors: Dima PROEFROCK, Monheim am Rhein (DE); Michael TRUMMER, Monheim am Rhein (DE)

(73) Assignee: JENOPTIK Robot GmbH, Monheim am Rhein (DE)

(21) Appl. No.: 18/711,569

(22) PCT Filed: Nov. 16, 2022
(86) PCT No.: PCT/EP2022/082141

§ 371 Date: May 17, 2024

(30) Foreign Application Priority Data
Nov. 17, 2022 (DE) 10 2021 130 032.0

(51) Int. Cl. G08G 1/015; G08G 1/052

(52) U.S. Cl. CPC G08G 1/015; G08G 1/052

(57) ABSTRACT

A method for recognizing the validity of a vehicle parameter. The method comprises a step of reading at least one first parameter and at least one second parameter, wherein the first parameter represents a first physical variable of the vehicle or a variable derived from the first physical variable, and the second parameter represents a second physical variable of the vehicle or a variable derived from the second physical variable. A distinguishing criterion for recognizing the validity of the vehicle parameter of the vehicle using a combination of the first and second parameter is also read. The method also comprises a step of assigning the vehicle parameter as a valid vehicle parameter if a combination of the first and the second parameter meets the distinguishing criterion.

The approach presented here provides a method and a device for recognizing the validity of a vehicle parameter according to the main claims.

In modern traffic monitoring systems, the problem often arises of classifying an object that is recognized in a monitoring or detection area of this traffic monitoring system with sufficient accuracy or understanding it as a valid vehicle parameter, making it difficult to automatically recognize a traffic rule that applies to this object. For example, in the case of such a traffic monitoring system, it is sometimes not possible to reliably recognize whether a vehicle falls into the vehicle class of trucks or vehicles with a gross weight of more than 7.5 t and thus whether a different speed limit applies to such a vehicle than to other motor vehicles. The measurement of valid measured speed values is also of central importance for the legal assessment of a traffic rule violation, as otherwise a sanction cannot be legally imposed on the driver without any doubt.

It is also conceivable to monitor the use of lanes by different types of vehicles in order to be able to thereby realize automatic traffic density measurement, for example. If, for example, a vehicle in a lane is recognized as a car or truck, but this vehicle is actually a motorcycle, this leads to an incorrect calculation of the traffic density in the lane in question.

In order to solve such problems, the present approach demonstrates a way in which the recognition of the validity of a vehicle parameter can be significantly improved in terms of its precision and simplified numerically or circuitry-wise.

The approach proposed herein provides a method for recognizing the validity of a vehicle parameter, wherein the method comprises the following steps:
reading at least one first parameter and at least one second parameter, wherein the first parameter represents a first physical variable of the vehicle or a variable derived from the first physical variable, and the second parameter represents a second physical variable of the vehicle or a variable derived from the second physical variable, wherein a distinguishing criterion for recognizing the validity of the vehicle parameter is also read using a combination of the first and second parameter; and
assigning the vehicle parameter as a valid vehicle parameter if a combination of the first and the second parameter meets the distinguishing criterion.

In the present case, a validity of a vehicle parameter can be understood to mean a parameter which reflects the quality of the vehicle parameter. For example, a vehicle parameter can then be understood as valid if it meets defined criteria. A vehicle parameter recognized as valid can be used, for example, for determining one or more other vehicle parameters, wherein such another vehicle parameter can be, for example, a current speed or a vehicle class. In the present case, a parameter can be understood to mean a physical variable of the vehicle, for example a speed, a spatial dimension, a position or the like, or also a variable derived from these variables, such as an acceleration at a certain time of detection. The first physical variable may have been detected at the same time as the second physical variable. In the present case, a distinguishing criterion can be understood to mean a one-dimensional or multi-dimensional threshold which enables a vehicle to be assigned to a vehicle class. In the present case, a combination of the first and the second parameter can be understood to mean a linking of the first and second parameters, for example in the form of a tuple, which enables the vehicle to be assigned to the corresponding vehicle class on the basis of a plurality of different parameters.

The approach presented here is based on the realization that by reading a plurality of parameters as the first and the second parameter (which can be based, for example, on different measured physical variables) and optionally a processing these parameters and subsequently linking of these parameters or processed parameter values to the combination, the validity of a vehicle parameter can be recognized very well. If, for example, an object is recognized which has a high speed (which can be detected by a radar sensor, for example) and at the same time has a small area (which can be recognized from a radar cross-section of the object from a signal from the radar sensor, for example), a combination can be formed from these variables as parameters, which combination can be examined below with regard to a relationship to the distinguishing criterion. If, for example, a motorcycle is traveling in the monitoring region of the traffic monitoring system, a rapid sequence of scans of this motorcycle by the radar sensor will result in combinations in which, for example, the first parameter is formed by the physical variable of the speed or a variable derived therefrom, and the second parameter is formed by the physical variable of the size of the vehicle, and wherein these combinations lie within a certain region of an evaluation space. Consequently, when a motorcycle is recognized as an object in the monitoring region, a small object with a high speed is recognized well, so that a vehicle parameter can be assigned to this object relatively reliably as the vehicle class “motorcycle”. This vehicle class can then be identified as a vehicle, for example, by the fact that the combination of parameters meets the distinguishing criterion, for example, lies within a delimited region of combination values, so that in this case the vehicle can be assigned the specific vehicle class, here for example the vehicle class motorcycles, very reliably.

Alternatively, it is also conceivable, for example, that a distance of the object from the sensor is used as the first parameter and a size of the object is used as the second parameter, for example using a radar cross-section, in order to recognize a speed of this object as valid using a combination of the first parameter and the second parameter. If, for example, a distance of the object from the sensor is recognized as small and at the same time a size of the object is recognized as very large, it can be assumed that a speed measurement is very precise and has a low susceptibility to error, since reflections of radar beams from other objects may be less important for the evaluation of the detected speed of the observed object. In this way, the vehicle parameter “speed” can thus also be verified or recognized as valid or assigned by the combination of two other parameters.

The approach proposed here offers the advantage of enabling very precise recognition of the validity of a vehicle parameter through a very inexpensive and technically easy to implement linking of different parameters with a subsequent investigation of this link or combination. At the same time, there are further optimization possibilities described below, which allow a further increase in precision to be achieved with an insignificant increase in numerical or circuit complexity.

A particularly advantageous embodiment of the approach proposed here is one in which, in the step of reading, a distinguishing criterion is read which delimits a region of tuples that are formed by combinations of the first and second parameters as elements of the tuple, wherein the vehicle parameter is assigned as a valid vehicle parameter in the step of assigning if the combination of the first and second parameters lies within this region.

A region can be understood to mean, for example, a two-dimensional subregion in a plane spanned by the first and second parameters. In the present case, an element of a tuple can be understood to mean a component of this tuple, wherein this tuple represents or maps a combination of a specific first parameter with at least one specific second parameter. Such an embodiment offers the advantage that, by defining or using this region as a distinguishing criterion, a technically very easy-to-implement possibility is opened up, for example, to recognize in a plane spanned by the first and second parameters that certain combinations of first and second parameters lie within the defined region, and then to assign the tuple as a valid vehicle parameter. In this way, it is only necessary to check whether combinations of the first and second parameters occur in this region.

Furthermore, an embodiment of the approach proposed here is also favorable, in which a distinguishing criterion is read during the step of reading, in which the distinguishing criterion represents at least one subregion which is different from the region and/or is arranged separately from the region. Such an embodiment of the approach proposed here offers the advantage that different aspects or, for example, signal reflections can also be used to identify a valid vehicle parameter, which do not result in a single contiguous region as a distinguishing criterion for assigning the vehicle parameter as a valid vehicle parameter.

Specifically, according to one embodiment of the approach proposed here, a speed, a position, a recognized variable of the vehicle, a position or a parameter representing a quality of a physical measurement at a certain point in time or a parameter formed from one of these physical quantities can be read as the first or the second parameter in the step of reading. Such an embodiment of the approach proposed here offers the advantage of using, on the one hand, measurement variables that can be detected very easily as parameters and, on the other hand, the use of parameters that enable combinations with which a high degree of precision can be achieved when assigning the vehicle parameter as a valid vehicle parameter.

A particularly favorable embodiment of the present approach is one in which vehicle parameters are recognized as not being valid vehicle parameters if the combination of the first and the second parameter does not meet the distinguishing criterion. Such an embodiment offers the advantage of being able to avoid a possible incorrect assignment of the vehicle parameter as a valid vehicle parameter as far as possible if the parameter values are unclear.

According to a further embodiment of the approach presented here, a further distinguishing criterion can also be read during the step of reading, which delimits a further region of tuples that is at least partially different from the region which is formed by combinations of the first and the second parameter as objects. In the step of assigning, the vehicle parameter can then be assigned as a valid vehicle parameter if the combination of the first and the second parameter is within the region and not within the further region. Such an embodiment of the approach proposed here offers the advantage that, for example, one or more specific regions (which are referred to here as further regions) of the combinations of first and second parameters can be regarded as possibly based on highly erroneous measured values or parameters, so that if a combination of parameters in this further region exists, an assignment of the vehicle parameter as a valid vehicle parameter should be avoided as far as possible. In this way, an incorrect assignment of the vehicle parameter as a valid vehicle parameter can also be avoided as far as possible.

Furthermore, according to one embodiment of the approach presented here, a step of determining a property of the vehicle using a vehicle parameter that has been assigned as a valid vehicle parameter, in particular wherein the determined property of the vehicle represents a speed of the vehicle or a vehicle class into which the vehicle has been categorized. In the present case, a vehicle class can be understood to mean a type or a category of vehicles, for example the class of passenger cars, trucks, motorcycles, working machines, or the like. Such an embodiment offers the advantage of being able to classify vehicles especially from this vehicle classes very precisely in order to be able to specifically identify vehicles from these difficult-to-recognize vehicle classes as precisely as possible. The speed of the vehicle, for example, can also be identified as precisely as possible with such a measure.

In order to be able to take into account a movement path of the vehicles into the monitoring region, for example, a time component of the parameters can also be taken into account for the formation of the corresponding combination. Accordingly, according to one embodiment of the approach proposed here, combinations of a plurality of first parameters detected at different points in time and a plurality of second parameters detected at different points in time can also be used in the step of assigning. Such an embodiment of the approach proposed here offers the advantage of enabling an even greater precision in the assignment of the vehicle parameter as a valid vehicle parameter by taking into account a temporal progression of the parameters.

In order to be able to realize the approach proposed here, according to one embodiment, a method for forming a distinguishing criterion for recognizing the validity of a vehicle parameter is also presented, wherein the method comprises the following steps:
reading first parameters and second parameters, wherein the first parameters represent a first physical variable or a variable derived from the first physical variable of a valid vehicle parameter of the vehicle, and the second parameters represent a second physical variable or a variable derived from the second physical variable of a valid vehicle parameter of the vehicle; and
determining the distinguishing criterion as that region of combinations of the first and second parameters whose frequency of occurrence is above a threshold in order to form the distinguishing criterion.

A frequency of occurrence can be understood to mean a number of instances of the relevant combination of a specific first and a specific second parameter.

Such an embodiment offers the advantage that the distinguishing criterion can now be determined by a learning algorithm, so that this distinguishing criterion can be used in a variant of a method described here in a technically simple manner and nevertheless provide precise results for assigning a vehicle to a vehicle class.

A particularly advantageous embodiment of the approach proposed here is one in which further first parameters and further second parameters are read in the step of reading, wherein the further first parameters are read as a further first physical variable or a variable derived from the further first physical variable of a non-valid vehicle parameter of the vehicle, and the further second parameters are read as a further second physical variable or a variable derived from the further second physical variable of a non-valid vehicle parameter of the vehicle and wherein, in the step of determining, an exclusion region of combinations of the further first and further second parameters whose frequency of occurrence is above a threshold is determined, in particular wherein a safety region is determined by which the exclusion region is increased in order to determine a further region for forming the distinguishing criterion. By using such an exclusion region or additionally the safety region, it is possible to prevent a vehicle parameter from not being classified as a valid vehicle parameter, for example due to minor measurement errors when determining the corresponding parameters and the subsequent formation of the respective combination. By using this safety region, which increases the region by 10%, for example, the robustness of the assignment of the vehicle parameter as a valid vehicle parameter can thus be increased.

According to one embodiment of the approach proposed here, in the step of reading, a speed, a position, a detected variable of the vehicle or a parameter representing a quality of a physical measurement at a certain point in time or a parameter formed from one of these physical variables can also be read as the first or second parameter. Such an embodiment also enables precise and simple determination of the vehicle parameter as a valid vehicle parameter for the vehicle to be analyzed.

In order to obtain the largest possible training set of data for training the algorithm for forming the distinguishing criterion, according to an advantageous embodiment of the approach proposed here, in the step of determining, a frequency of occurrence of combinations of a plurality of first parameters detected at different points in time and a plurality of second parameters detected at different points in time can be used in order to form the region as part of the distinguishing criterion.

These methods can be implemented in software or hardware, for example, or in a hybrid form of software and hardware, for example in a control unit or a device.

The approach presented here also creates a device that is designed to carry out, control, or implement the steps in corresponding devices in a variant of a method presented here. This embodiment variant of the invention in the form of a device can enables the object underlying the invention to be solved quickly and efficiently.

For this purpose, the device can have at least one computing unit for processing signals or data, at least one storage unit for storing signals or data, at least one interface to a sensor or an actuator for reading sensor signals from the sensor or for outputting data or control signals to the actuator, and/or at least one communication interface for reading or outputting data that are embedded in a communication protocol. The computing unit can, for example, be a signal processor, a microcontroller, or the like, wherein the memory unit can be a flash memory, an EEPROM, or a magnetic memory unit. The communication interface can be designed to read or output data wirelessly and/or in a line-bound manner, a communication interface that can read or output line-bound data being able, for example, to read these data electrically or optically from a corresponding data transmission line or output them into a corresponding data transmission line.

In the present case, a device can be understood to mean an electrical device that processes sensor signals and as a function thereof outputs control and/or data signals. The device may have an interface, which may be designed as hardware and/or software. In a hardware embodiment, the interfaces can, for example, be part of what is known as an ASIC system, which includes a wide variety of functions of the device. However, it is also possible for the interfaces to be separate integrated circuits or at least partially consist of discrete components. In a software design, the interfaces may be software modules which, for example, are present on a microcontroller in addition to other software modules.

Also advantageous is a computer program product or computer program with program code which can be stored on a machine-readable carrier or storage medium, such as a semiconductor memory, a hard disk memory, or an optical memory, and is used to carry out, implement, and/or control the steps of the method according to one of the embodiments described above, in particular if the program product or program is executed on a computer or a device.

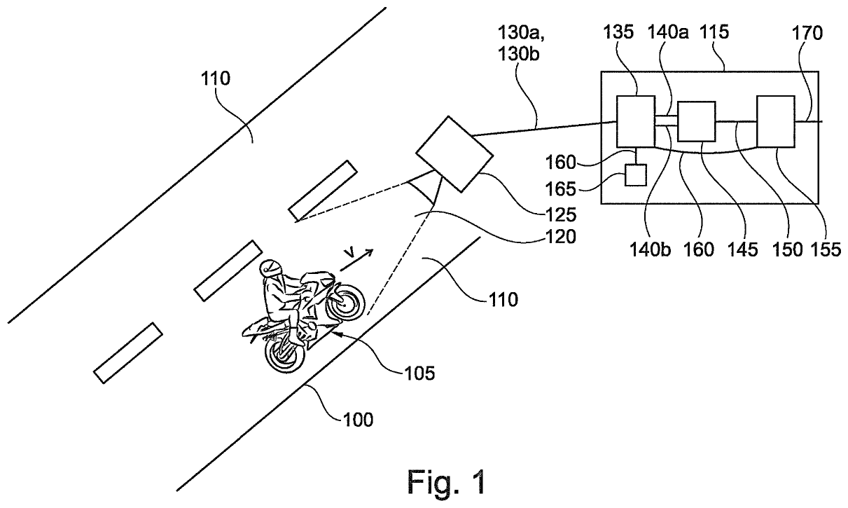

Embodiments of the approach presented here are shown in the figures and explained in more detail in the following description. In the figures: FIG. 1 shows a schematic representation of a road, wherein a vehicle is located on one of the lanes of this road, and a parameter of this vehicle (for example the vehicle class) is to be determined or validated using an appropriately designed device for recognizing the validity of a vehicle parameter of the vehicle;

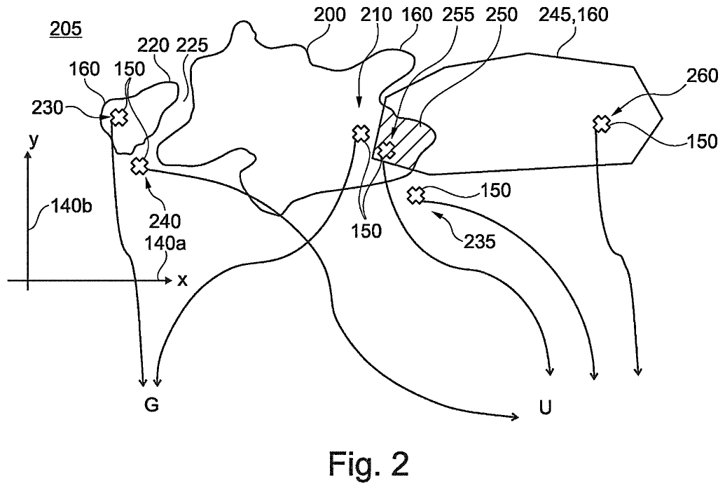

FIG. 2 shows a schematic representation of an exemplary embodiment of a procedure for recognizing the validity of a vehicle parameter using the distinguishing criterion;

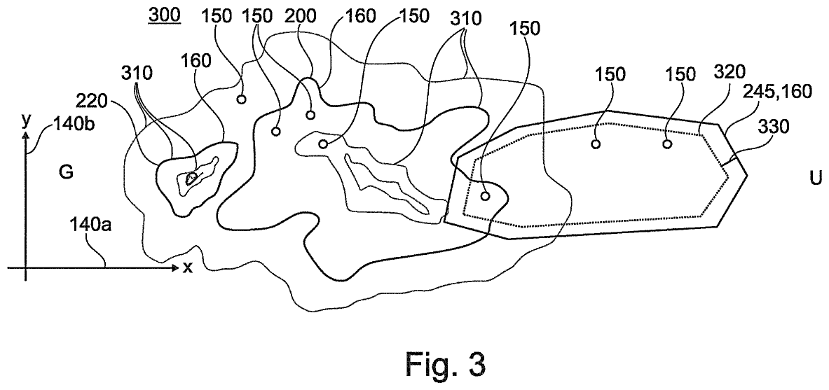

FIG. 3 shows a schematic representation of the procedure of an exemplary embodiment of a method for forming the distinguishing criterion for recognizing the validity of a vehicle parameter of a vehicle;

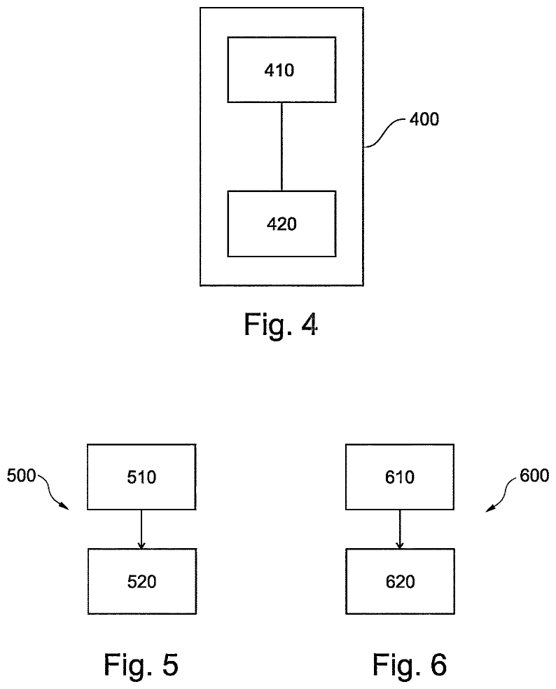

FIG. 4 shows a block diagram of an exemplary embodiment of a device for forming the distinguishing criterion for recognizing the validity of a vehicle parameter of a vehicle;

FIG. 5 shows a flowchart of an exemplary embodiment of a method for recognizing the validity of a vehicle parameter using the distinguishing criterion; and

FIG. 6 shows a flowchart of an exemplary embodiment of a method for forming the distinguishing criterion for recognizing the validity of a vehicle parameter of a vehicle.

In the following description of advantageous embodiments of the present invention, the same or similar reference signs are used for the elements that are shown in the different figures and have a similar effect, a repeated description of these elements being dispensed with.

FIG. 1 shows a schematic representation of a road 100, wherein, on this road 100, a vehicle 105, in this case a motorcycle, is located on one of the lanes 110 of this road 100, and the class of this vehicle 105 is to be determined using a corresponding device 115. For this purpose, it is first determined whether the vehicle class is valid as a recognized vehicle parameter, i.e. whether it can be recognized with sufficient precision. For example, the vehicle 105 is detected in a monitoring region or detection region 120 of a sensor 125, and a plurality of physical variables 130a and 130b are measured. For example, the sensor 125 can be designed as a radar sensor which determines a speed v of the vehicle 105 as a first physical variable 130a and, for example, determines a radar cross-section or a size of the vehicle 105 from the strength or intensity of a signal reflected by the vehicle 105 and outputs this as a second physical variable 130b. However, it is also conceivable that the sensor 125 also determines further physical variables such as a position of the vehicle 105 on the roadway 110, or that the sensor 125 also has an additional partial sensor, not shown in FIG. 1, which detects a physical variable of the vehicle 105 that is not determined, for example, by evaluating a radar beam signal. For example, such a partial sensor may be a camera for optically evaluating the vehicle 105 in the detection region 120.

In the device 115 for recognizing the validity of a vehicle parameter, which can be recognized here as the vehicle class of the vehicle 105, the physical variables 130a and 130b are first read in a reading interface 135. Subsequently, the first physical variable 130a or a value derived therefrom (for example an acceleration, where the first physical variable represents a speed which is differentiated according to time) is output as the first parameter 140a. The second physical variable 130b or a value derived therefrom is output, for example, as the second parameter 140b. In a linking unit 145, for example, a combination 150 of the first parameter 140a and the second parameter 140b is now determined as a tuple with the first parameter 140a as the first object and the second parameter 140b as the second object. This combination 150, which now represents a simultaneous occurrence of a specific first parameter 140a with a specific second parameter 140b, is then further processed in an assignment unit 155.

According to the procedure described above, a decision criterion 160 is then obtained from the reading interface 135 in the assignment unit 155, wherein the reading interface 135 itself reads out this differentiation criterion from a memory 165. This distinguishing criterion 160 is then used, for example, in accordance with the procedure described in more detail below, in order to assign a validity of the recognized vehicle parameter, in this case the vehicle class of the vehicle 105 detected in the detection region 120, in the present case for example the vehicle class “motorbike”, to this vehicle 105, and output it as a corresponding vehicle parameter signal 170 for subsequent processing in a device not shown in FIG. 1.

FIG. 2 shows a schematic representation of the procedure for recognizing the validity of a vehicle parameter (such as the vehicle class in this case) using the distinguishing criterion 160. In this case, FIG. 2 shows a plane which, in accordance with the representation of the coordinate system on the left-hand side, is spanned in the dimension of the first parameter 140a (x) and the second parameter 140b (y). The individual possible combinations 150 of a first parameter 140a and a second parameter 140b each are shown in the representation from FIG. 2 by crosses, which represent the relevant combination 150. Furthermore, FIG. 2 also shows the embodiment of the distinguishing criterion 160 in the form of a delimited region 200 of the plane 205 as a subregion of the distinguishing criterion 160, which encloses a certain region of combinations 150 of the first parameter 140a and the second parameter 140b. A combination 150, such as the combination 150 at position 210, is thus within this region 200 and is interpreted as a combination 150 to which the validity of the vehicle parameter can be assigned for which the distinguishing criterion 160 is provided. For the combination 150 to be recognized in the region G of the valid, acceptable values (or in the region 200 or 220 described in more detail below), it should also be fulfilled that the combination 150 is not in the region 245, which is also described in more detail below.

A subregion 220 of the distinguishing criterion 160 can may also be provided, which delimits a region of combinations 150 of the first parameter 140a and the second parameter 140b from other combinations 150 of these parameters, wherein the region 200 and the subregion 220 are separated from one another, for example by a channel 225 of combinations of first parameters 140a and second parameters 140b which are not to be assigned to the respective relevant vehicle class. Thus, for example, a combination 150 of a first parameter 140a and a second parameter 140b may occur at the position 230, wherein this combination 150 or the vehicle 105 providing physical variables 130 that result in this combination 150 at the position 230, are evaluated as a vehicle 105 of the vehicle class represented by the distinguishing criterion 160 used.

Those combinations 150 which can result in a valid measurement G or a valid recognition of the vehicle parameter of the vehicle, for example the classification in the relevant vehicle class, are therefore those combinations 150 which are located at positions 210 and 230 in the plane 205 spanned by the first parameter 140a and the second parameter 140b. In this case, those combinations 150 should not be in region 245.

However, if combinations 150 of the first parameter 140a and the second parameter 140b occur, for example, at positions 235 and 240, it can be recognized by using the distinguishing criterion 160 that these combinations 150 are located outside the region 200 or the subregion 220, so that these combinations 150 at position 235 and position 240 are recognized as an invalid measurement U or an invalid recognition of the vehicle class as a vehicle parameter. This can be interpreted, for example, in such a way that the parameters 140a or 140b or the measured physical variables on which these parameters are based were not measured with sufficient precision or the vehicle 105 cannot be clearly categorized into a vehicle class as a vehicle parameter, so that an assignment of the vehicle class as a vehicle parameter using the distinguishing criterion 160 would not be sufficiently precise and is thus rejected, i.e. interpreted as not valid.

It is also conceivable that a further region 245 is defined, which designates a region of combinations 150 of the first parameter 140a and of the second parameter 140b, which combinations 150 lying therein are definitely not to be assigned to the relevant vehicle class as a valid vehicle parameter for the vehicle 105. For example, this further region 245 may represent combinations 150 which explicitly describe a vehicle 105 that is not to be assigned to the relevant vehicle class as a valid vehicle parameter. In a special case, for example, the further region 245 may also overlap the region 200 in an overlap region 250, so that a combination 150 at position 255 is explicitly not to be assigned to the relevant vehicle class as a valid vehicle parameter, although this combination 150 at position 255 is within the region 200. This combination 150 at the position 255 should therefore be considered as an invalid measurement U. A combination 150 at the position 260 is also to be considered as an invalid measurement U since it lies within the further region 245. For example, region 245 alone is sufficient to recognize the result as being in region U of invalid combinations. Conversely, a position of the combination 150 in regions 200 or 220 is not sufficient to recognize this combination as being in the valid value range G (i.e. lying in the region 200 and/or 220); it should also apply here that the combination 150 does not touch region 245. It is advantageous here that the region 245 should be present. If the option of non-existence is to be taken into account, then the following should be correspondingly defined in each case: the combination 150 is in the non-critical, i.e. valid region G, if it lies in the region 200 or 220 and the region 245 does not exist; otherwise, if the region 245 exists, if the combination 150 lies in the region 200 or 220 and not in the region 245.

Such a procedure for recognizing the vehicle class of the vehicle 105 as a valid vehicle parameter offers a particular advantage, since only a combination 150 of the first parameter 140a and the second parameter 140b needs to be formed using technically simple means, and it can be checked whether this combination 150 lies within the region 200 or the subregion 220 (and possibly not within the further region 245). In this way, a precise classification of the vehicle 105 in the detection region 120 of the sensor 125 can be achieved very quickly with technically very simple means, which can then also be evaluated as a valid vehicle parameter.

As can already be seen from the preceding embodiments, the use of distinguishing criterion 160 plays an important role in the implementation of the approach proposed here. For this reason, a way of determining the distinguishing criterion 160 is described below so that, for performing the recognition of the vehicle class of the vehicle, it can be stored in the memory 165 and then used in the assignment unit 155 according to the representation shown in FIG. 1.

FIG. 3 shows a schematic representation of the procedure of a method for forming the distinguishing criterion for recognizing the validity of a vehicle parameter. Here, FIG. 3 again shows a plane 300 (which substantially corresponds to the plane 205 of FIG. 2, but relates to a different or extended exemplary embodiment), which is spanned by the dimension of the first parameter 140a and the second parameter 140b. In a training phase or learning phase, various physical variables of a vehicle are now read into a vehicle parameter known for recognizing a valid vehicle parameter, such as a vehicle class recognized as valid, and first parameters 140a and second parameters 140b are extracted therefrom, which are combined to form the combinations 150. These corresponding combinations 150 are now shown as circles in the plane 300. The frequencies of occurrence of the combinations 150, which are represented by circles in FIG. 3, are now entered in the plane 300 so that these frequencies of occurrence of the relevant combinations 150 can be mapped into a third dimension from the drawing plane, so to speak. According to the representation from a cartography, it is now possible to determine contour lines 310, so to speak, that connect positions to one another at which the combinations 150 have the same frequency of occurrence. If, for example, a threshold is now defined for the frequency of occurrence from which the combinations 150 represent a vehicle 105 that the corresponding vehicle parameter is to be recognized as valid and is to be assigned as a valid vehicle parameter (which also corresponds here to the vehicle class from which the physical variables of the vehicle were determined for the training phase or learning phase), such a contour line 310 can be determined which can be used as a distinguishing criterion 160 or as a region 200 or subregion 220 for subsequent recognition of the vehicle class in the device 115. Those combinations 150 that lie within the region 200 or subregion 220 have a greater probability of occurrence or frequency of occurrence than combinations 150 that lie outside the region 200 or subregion 220. At the same time, an exclusion region 320 or the further region 245 can again be determined as a contour line of frequencies of occurrence or by forming the convex hull for a few data examples, which encloses an area of combinations 150, which should not lead to an assignment of vehicle parameters assessed as valid. In particular, determining the region 320 as a convex hull allows the method to be secured in a transparent, comprehensible and easily parameterized manner, if at the same time:
only a few data examples are available for training, and
the class U has a particularly high criticality within the scope of the underlying application of the method.

In order to ensure that no erroneous measurement values lead to combinations 150 that lie just outside the region or exclusion region 320, the boundaries of the region 320 can be enlarged by a safety region 330 around the exclusion region 320. In the representation from FIG. 3, for reasons of representation, only the safety region 330 around the exclusion region 320 is shown, although the region 200 can of course also be secured or enlarged accordingly by providing such a safety region. As a result, it can largely be ensured that all combinations 150 in the vicinity of the region 200 are safely within the boundaries of the wider region 245 by selecting the region boundaries of the region 200 or exclusion region 320.

The formation of the distinguishing criterion 160 for recognizing a vehicle class of a vehicle can thereby take place outside the device 115 shown in FIG. 1, for example in a laboratory environment. However, it is also conceivable that the method for forming as continuous learning functions is also carried out on site in the device 115.

It is also conceivable that a transfer of the procedure from 2D to n dimensions can take place. The preceding embodiments refer to respective combinations 150, i.e. 2-tuples of values. An embodiment variant with n-tuples of values is also conceivable. In each case, combinations of n individual values per vehicle are therefore considered. The region of the valid measurements is determined, for example, by an n-dimensional density estimate and an associated iso-surface. The region of the invalid measurements results, for example, as an n-dimensional convex hull and safety distance.

FIG. 4 shows a block diagram of a device 400 for forming a distinguishing criterion for recognizing the validity of a vehicle parameter, wherein the device 400 has a reading interface 410 for reading first parameters and second parameters, wherein the first parameters represent a first physical variable or a variable derived from the first physical variable of a valid vehicle parameter of the vehicle, and the second parameters represent a second physical variable or a variable derived from the second physical variable of a valid vehicle parameter of the vehicle. Furthermore, the device 400 comprises a unit 420 for determining the distinguishing criterion 160 as at least that region (200) of combinations of the first and second parameters whose frequency of occurrence is above a threshold in order to form the distinguishing criterion.

FIG. 5 shows a flowchart of a method 500 for recognizing the validity of a vehicle parameter, the method 500 comprising a step 510 of reading at least a first parameter and at least a second parameter, wherein the first parameter represents a first physical variable of the vehicle or a variable derived from the first physical variable, and the second parameter represents a second physical variable of the vehicle or a variable derived from the second physical variable, wherein further a distinguishing criterion for recognizing the validity of the vehicle parameter of the vehicle is read using a combination of the first and second parameter. Furthermore, the method 500 comprises a step 520 of assigning the vehicle parameter as a valid vehicle parameter if a combination of the first and the second parameter meets the distinguishing criterion.

FIG. 6 shows a flowchart of a method 600 for forming a distinguishing criterion for recognizing the validity of a vehicle parameter. Method 600 comprises a step 610 of reading first parameters and second parameters, wherein the first parameters represent a first physical variable or a variable derived from the first physical variable of a valid vehicle parameter of the vehicle, and the second parameters represent a second physical variable (130b) or a variable derived from the second physical variable of a valid vehicle parameter of the vehicle. Furthermore, the method 600 comprises a step 620 determining the distinguishing criterion as that region of combinations of the first and second parameters whose frequency of occurrence is above a threshold in order to form the distinguishing criterion.

In summary, it should be noted that an important basis of the approach presented here maps the solution of a two-class problem. Features of both classes exist in the form of vectors with a dimension greater than 1. The two classes differ in their criticality in the sense that permutations in one direction are significantly more serious than in the other direction. In this respect, the classification problem is asymmetrical. If the critical class of invalid vehicle parameters (which here defines the recognition of a vehicle of a certain vehicle class or the assignment of the vehicle to the certain vehicle class) is designated U, and the other class of valid vehicle parameters is designated G. If then an element of class U is classified as belonging to class G, this is much more critical than the other way around. In addition, only very few examples (training data points) of class U are known in the learning phase. The distribution of these examples should, for example, be assumed to be unknown. The distribution of the elements of U is not assumed to be reasonably estimable, due to the few known examples. According to an assumption, the training data of class G allow a meaningful and helpful estimation of the distribution.

Due to the criticality of class U, there are increased requirements for solving this problem. The training result should be identically reproducible. The class area of class U should be transparent and explicitly representable. It should also satisfy a reasonable assumption of continuity. There should be a transparent option for adjusting the risk buffer. These requirements are intended to ensure that no element of U is classified as G.

An object of the approach proposed here can be seen, inter alia, in the solution of a two-class problem in the form described. In the sense of asymmetry, the target criteria are, with priority 1, to avoid classifying an element of the critical class as non-critical, and with priority 2, to maximize the number of elements of the non-critical class classified as correct. The results of the learning method should be identically reproducible. It should be possible to apply the learning method with very few training examples for the critical class. Due to the criticality of one of the classes, the separating function learnt (i.e. the distinguishing criterion) should be transparent and comprehensible. In particular, the possibility of an explicit description is useful. The separating function should fulfill at least one useful continuity condition. The learning outcome should enable a reasonable adjustment of the risk buffer.

The proposed method includes, in particular, a learning method, forms of representation for the classes as learning outcome and the procedure for the execution phase of the classification.

Problems that have more than two classes are conceivable. The application of the method described is intended to solve these problems, provided that at least one critical and at least one non-critical class exist within them.

The approach proposed here for achieving the object described above is divided, inter alia, into a learning step and an execution step.

In the learning step (training), the representations for the classes G and U are generated using the training data. For class G, its distribution density is first estimated. Advantageously, this can take place without a model, for example by means of kernel density estimation. For the estimated distribution density, a minimum value is defined as part of training. This minimum value can be zero. The estimated distribution density and the minimum value of the are used to determine the area, i.e. the region that results from the combination of regions 200 and 220 within which elements of class G are expected (G area). The shape of this area is free and corresponds to an ISO line of the estimated distribution density. A representation can take place, for example, by an occupancy map. For class U, the convex hull is determined using all the training data. A safety distance to the convex hull is also defined. This step can involve both the expansion of the convex hull and the distribution density of class G. For the execution phase, only the convex hull (U area, region 245) corrected by the safety distance is decisive with respect to class U. The minimum value for G and the safety distance for U can be determined by means of cross-validation.

In the execution phase, a new element e of unknown class can be classified in class G or U, i.e. assigned to a vehicle class or not assigned to this vehicle class. The classification is based on the following exemplary process:
If e lies within or on the boundary of the U area, an assignment to class U takes place.
If e lies outside the U area and outside the G area, an assignment to class U takes place.
If e lies outside the U area and within the G area, an assignment to class G takes place.

The approach proposed here has the following combination of advantages over a conventional prior art approach:
The approach proposed here can be applied with few data points with respect to the critical class U.
The approach proposed here provides identically reproducible results during learning and execution.
The approach proposed here provides, as a result of the learning phase, a separating function (distinguishing criterion 160) in the form of, for example, a convex polygon and an area well defined by data, wherein the latter corresponds, for example, to an ISO line of the distribution of the non-critical measurements.
In particular, the area U of critical measurements obeys a sensible, data-driven, piecewise continuity assumption, for example in the form of the convex hull around the known critical measurements plus a risk buffer. At the same time, the nature of the design of areas U and G offers a high degree of ability to separate vehicle parameters.
The approach presented here allows the transparent adjustment of a risk buffer in the form of the safety distance around the convex hull of the critical measurements.
The approach presented here allows an explicit representation of the area K of the critical measurements.
The approach presented here ensures that each individual measurement within the critical area U or outside the non-critical area G is classified as critical and invalid.
The calculations in the execution phase can be carried out very efficiently.

There are low requirements for the underlying hardware, and real-time applications are possible.

By means of the combinations used here by way of example, scalar features x and y can be used as physical measured variables or values derived from one or more physical measurement variables, which are taken as a basis as parameters for the combinations. The physical measured variables can specify the position, quality, and time of the individual measuring points of an object. Pre-processing can also be carried out, for example in the calculation of the derivation. Several elementary measured variables can then be summarized into one object or combination 150 (segmentation) at one point in time. It is also conceivable to summarize objects over several points in time to form an object history (tracking). There are also options for deriving further variables, which can also be applied in layers. Shape features such as straightness as the sum of the gradient amounts of adjacent points, outlier analysis as extreme value observation on the reference side of an object, evaluation of symmetry properties or progression features such as uniformity of movement based on outlier evaluation in regression, change in shape features over time based on variance can also be used to classify the objects as vehicles as well as possible.

If an exemplary embodiment comprises an “and/or” conjunction between a first feature and a second feature, this is to be read in such a way that the exemplary embodiment has both the first feature and the second feature according to one embodiment, and either only the first feature or only the second feature according to a further embodiment.

1. A method for recognizing the validity of a vehicle parameter, the method comprising:
reading at least one first parameter and at least one second parameter, wherein the first parameter represents a first physical variable of the vehicle or a variable derived from the first physical variable, and the second parameter represents a second physical variable of the vehicle or a variable derived from the second physical variable, wherein further a distinguishing criterion for recognizing the validity of the vehicle parameter of the vehicle is read using a combination of the first and the second parameter; and
assigning the vehicle parameter as a valid vehicle parameter if a combination of the first and the second parameter meets the distinguishing criterion.

2. The method according to claim 1, wherein, in the step of reading, a distinguishing criterion is read which delimits a region of tuples which is formed by combinations of the first and the second parameter as objects of the tuple, wherein, in the step of assigning, the vehicle parameter is then assigned as a valid vehicle parameter if a combination of the first and the second parameter lies within this region.

3. The method according to claim 2, wherein, in step of reading, a distinguishing criterion is read, for which the distinguishing criterion has at least one subregion which is different from the region and/or is arranged separately from the region.

4. The method according to claim 1, wherein, in step of reading as the first or the second parameter a speed, a position, a recognized variable of the vehicle, or a parameter representing a quality of a physical measurement at a specific time, or a parameter formed from one of these physical variables each is read.

5. The method according to claim 1, wherein, in the step of assigning, the vehicle parameter is recognized as a non-valid vehicle parameter if the combination of the first and the second parameter does not meet the distinguishing criterion.

6. The method according to claim 1, wherein, in the step of reading, a further distinguishing criterion is read which delimits a further region of tuples which is at least partially different from the region and which is formed by combinations of the first and the second parameter as objects, wherein, in the step of assigning, the vehicle parameter is then assigned as a valid vehicle parameter if the combination of the first and the second parameter lies within the region and not within the further region.

7. The method according to claim 1, further comprising a step of determining a property of the vehicle using a vehicle parameter that has been assigned as a valid vehicle parameter, in particular wherein the determined property of the vehicle represents a speed of the vehicle or a vehicle class into which the vehicle has been classified.

8. The method according to claim 1, wherein, in the step of assigning, combinations of a plurality of first parameters detected at different points in time and a plurality of second parameters detected at different points in times are used.

9. A method for forming a distinguishing criterion for recognizing the validity of a vehicle parameter, the method comprising:
reading of first parameters and second parameters, wherein the first parameters are a first physical variable or a variable derived from the first physical variable representing a valid vehicle parameter of the vehicle, and the second parameters are a second physical variable or a variable derived from the second physical variable representing a valid vehicle parameter of the vehicle; and
determining the distinguishing criterion as that region of combinations of the first and the second parameter whose frequency of occurrence is above a threshold in order to form the region as part of the distinguishing criterion.

10. The method according to claim 9, wherein, in the step of reading, further first parameters and further second parameters are read, wherein the further first parameters, a further first physical variable or a variable derived from the further first physical variable of a non-valid vehicle parameter of the vehicle, and the further second parameters, a further second physical variable or a variable derived from the further second physical variable of a non valid vehicle parameter of the vehicle are read, and wherein, in the step of determining, an exclusion region of combinations of the further first and the further second parameter whose frequency of occurrence is above a threshold or which lie within or on the boundary of the convex hull thereof is determined, in particular wherein a safety region is determined by which the exclusion region is enlarged in order to determine a further region for forming the distinguishing criterion.

11. The method according to claim 9, wherein, in the step of reading, as the first or the second parameter, a speed, a position, a recognized variable of the vehicle, or a parameter representing a quality of a physical measurement at a specific time, or a parameter formed from one of these physical variables each is read.

12. The method according to claim 9, wherein, in the step of determining, a frequency of occurrence of combinations of a plurality of first parameters detected at different points in time and a plurality of second parameters detected at different points in time is used in order to form the distinguishing criterion.

13. A device configured to execute and/or control the steps of the method according to claim 1 in corresponding units.

14. A computer program which is configured to execute and/or control the steps of the method according to claim 1.

15. A machine-readable storage medium on which the computer program according to claim 14 is stored.
